(19) United States
(12) Patent Application Publication
(10) Pub. No.: US 2026/0221048 A1
(43) Pub. Date: Jul. 30, 2026

(54) AUTOMATED GRADING OF USER-EXPANDED SENTENCES USING INTEGRATED PROGRAMMATIC AND SPECIALIZED GUIDED AND CONSTRAINED ARTIFICIAL INTELLIGENCE

(71) Applicant: 2hr Learning, Inc., Austin, TX (US)

(72) Inventors: Joshua Singer, San Antonio, TX (US); Cameron Kelley, Franklin, TN (US); Alex Stanciu, Palm Valley, PA (US)

(73) Assignee: 2hr Learning, Inc., Austin, TX (US)

(21) Appl. No.: 19/406,909

(22) Filed: Dec. 2, 2025

Related U.S. Application Data
(60) Provisional application No. 63/727,185, filed on Dec. 2, 2024.

(51) Int. Cl. G09B 7/04; G06F 40/253; G06F 40/30; G06F 40/40

(52) U.S. Cl. CPC G09B 7/04; G06F 40/253; G06F 40/30; G06F 40/40

(57) ABSTRACT

The system and method for guiding an Artificial Intelligence (AI) engine to automatically grade a user-expanded sentence using a plurality of sentence prefixes in writing activities. The grading system and grading process receives the user-expanded sentence from a user that builds upon an original sentence. The grading system and grading process utilizes a punctuation verification module to determine the user-expanded sentence ends with proper punctuation. A sentence capitalization verification module assesses whether the user-expanded sentence begins with a capital letter. A proper noun capitalization verification module verifies capitalization of proper nouns. A grammar verification module evaluates grammatical correctness. A conjunction usage verification module checks correctness of conjunction. A sentence expansion verification module identifies the user-expanded sentence including the original sentence. After the assessments, a prompt is generated, which directs the AI engine to conduct semantic analysis on the user-expanded sentence. Finally, through a grading module, the grade is generated.

### CROSS-REFERENCE TO RELATED APPLICATION(S)

This application claims the benefit under 35 U.S.C. § 119(e) and 37 C.F.R. § 1.78 of U.S. Provisional Application No. 63/727,185 which is incorporated by reference in its entirety.

### FIELD OF THE INVENTION

The present invention relates in general to the field of electronics, and more specifically to grading systems and grading processes to provide grades on user-expanded sentences using a plurality of sentence prefixes in writing activities.

### DESCRIPTION OF THE RELATED ART

A traditional grammar-checking system is utilized to ensure the correctness and appropriateness of conjunction usage in the sentence. The traditional grammar-checking system relies heavily on rule-based algorithms to identify errors. The traditional grammar-checking system uses predefined syntactic rules to evaluate whether a conjunction was placed correctly within the sentence and whether it conformed to basic grammatical standards. While effective to some extent in identifying errors, such approaches were limited in their ability to assess the contextual appropriateness of conjunctions. For example, they could determine if the conjunction like “and” or “but” was syntactically misplaced, but they often failed to evaluate whether the chosen conjunction conveyed the intended logical relationship between ideas in the sentence.

This lack of contextual understanding frequently resulted in incorrect assessments or overlooked errors in more complex sentences. As a result, the traditional grammar-checking system struggled with sentences where conjunctions carried semantic weight, such as those denoting subtle contrasts or conditions. Furthermore, rule-based methods lacked adaptability, often requiring extensive manual updates to account for evolving language use or variations across different writing styles and contexts.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary grading system to provide a grade on a user-expanded sentence using a plurality of sentence prefixes in writing activities.

FIGS. 2A and 2B (collectively referred to as “FIG. 2”) depict an exemplary grading process utilized by the grading system.

FIGS. 3-8 are exemplary user interfaces depicting interaction of the user.

FIG. 9 depicts an exemplary network environment in which the system of FIG. 1 and the process of FIG. 2 may be practiced.

FIG. 10 depicts an exemplary computer system.

### DETAILED DESCRIPTION

The system and method for guiding an artificial intelligence (AI) engine to automatically grade a user-expanded sentence using a plurality of sentence prefixes in writing activities. The grading system and grading process receives the user-expanded sentence from a user that builds upon an original sentence. The grading system and grading process utilizes a punctuation verification module to determine the user-expanded sentence ends with proper punctuation, a sentence capitalization verification module assesses whether the user-expanded sentence begins with a capital letter, a proper noun capitalization verification module verifies capitalization of proper nouns, and a grammar verification module to evaluate grammatical correctness. A conjunction usage verification module checks correctness of conjunction. A sentence expansion verification module identifies the user-expanded sentence including the original sentence. After the assessments, a prompt is generated, which directs the AI engine to conduct semantic analysis on the user-expanded sentence. Finally, through a grading module, the grade is generated.

The grading system and grading process are designed to enhance the quality of user-expanded sentences through multiple modular checks. The grading system and grading process includes the punctuation verification module that ensures sentences end with appropriate punctuation marks such as periods, question marks, or exclamation marks. Additionally, the sentence capitalization verification module checks if the initial character of the sentence is an uppercase letter. The proper noun capitalization verification module focuses on the correct capitalization of proper nouns according to predefined language rules, while the grammar verification module utilizes third-party tools to identify and address grammatical errors. Furthermore, the conjunction usage verification module evaluates the grammatical placement and contextual suitability of conjunctions, ensuring they are used correctly in the sentence. In addition to these checks, the AI engine conducts a two-step verification process, assessing the logical coherence and overall sense of the user-expanded sentence. Each step of this process leverages distinct semantic evaluation prompts provided by the prompt generator. Finally, the grading module offers a comprehensive breakdown of the assessment results, indicating aspects of correctness or errors in the user-expanded sentence and providing further information to facilitate improvement to create a robust framework for sentence verification, encompassing punctuation, capitalization, grammar, conjunction usage, and logical evaluation.

The system and method set forth herein address technical issues with generating the desired outputs described herein. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its(their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. Conventional approaches often do not recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

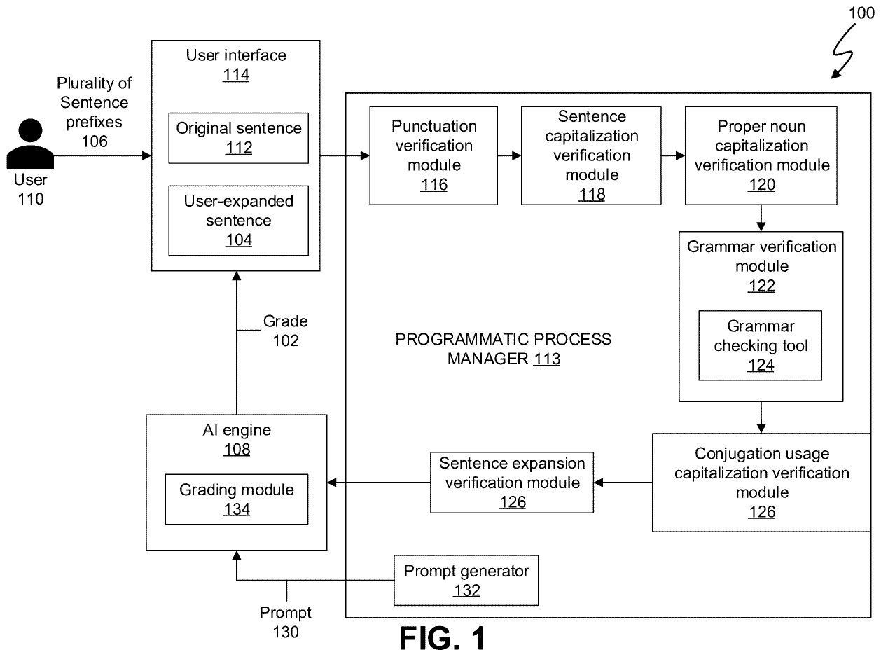

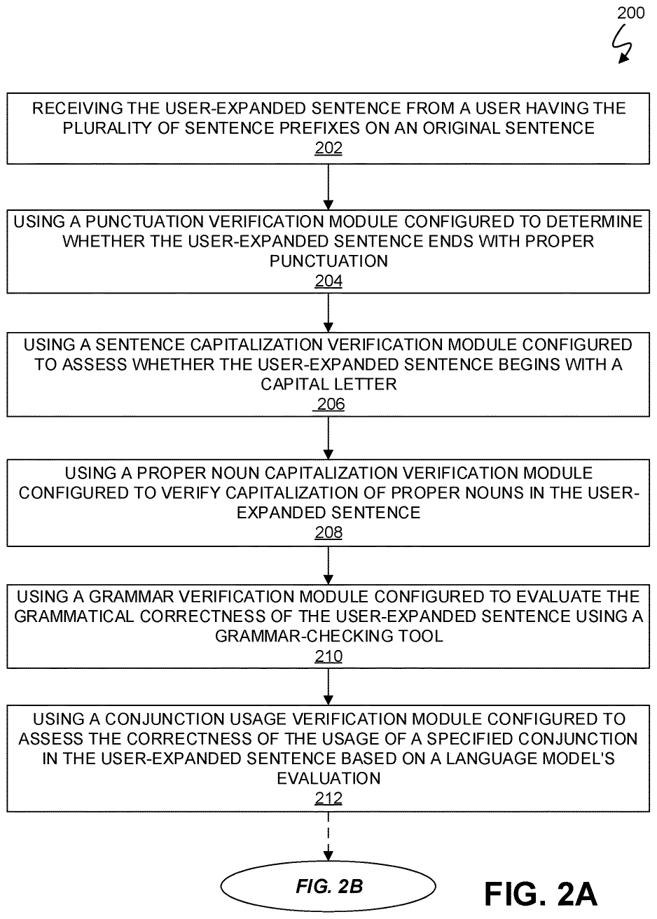

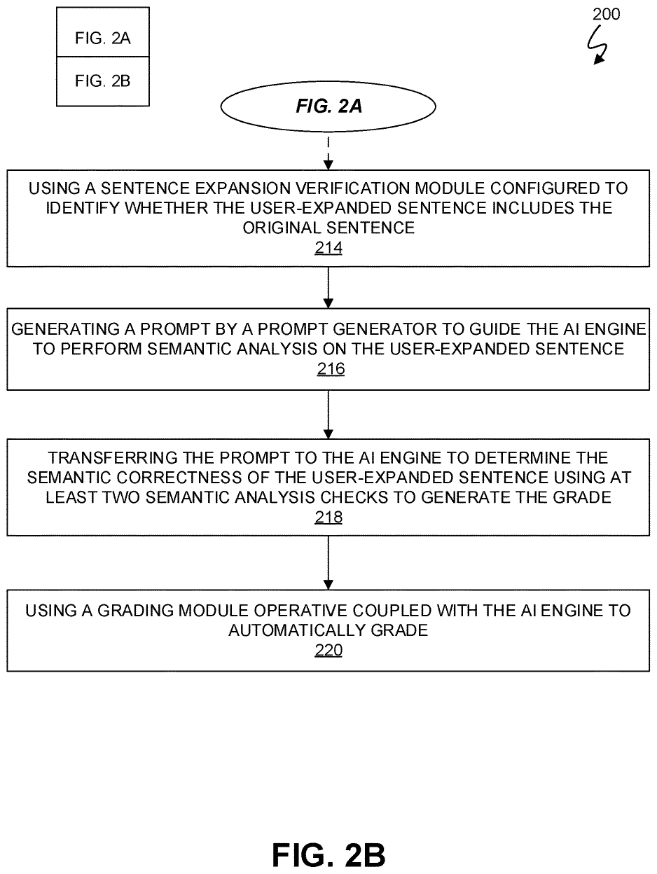

FIG. 1 depicts an exemplary grading system 100 to provide a grade 102 on a user-expanded sentence 104 using a plurality of sentence prefixes 106 in writing activities. FIG. 2 depicts an exemplary grading process 200 utilized by the grading system 100. The Artificial Intelligence (AI) engine 108 is configured to generate the grade 102 based on the user-expanded sentence 104 using a plurality of sentence prefixes 106 used by a user 110 in writing activities. The user 110 utilizes the plurality of sentence prefixes 106 to expand an original sentence 112 displayed on a user interface 114 to provide the user-expanded sentence 104.

Referring to FIGS. 1 and 2, the grading system 100 integrates programmatic process manager 113 with an AI engine 108 to automatically grade a user-expanded sentence using a plurality of sentence prefixes in writing activities. The programmatic process manager 113 includes multiple modules and integrates the AI engine 108 to, for example, programmatically grade a user-expanded sentence 104. In operation 202, the punctuation verification module 116 of the programmatic process manager 113 receives from the user 110 the user-expanded sentence 104 having the plurality of sentence prefixes 106 on the original sentence 112. The original sentence 112 is a statement or a phrase that is provided to the user 110 on the user interface 114 serves as the starting point. The purpose of the original sentence 112 is to provide a base or framework for subsequent elaboration by the user 110. The original sentence 112 represents a factual statement requiring the plurality of sentence prefixes 106 which gives information in a formal or definite way and makes sense. The plurality of sentence prefixes 106 are fragments, phrases, or partial structures that precede the original sentence 112. The plurality of sentence prefixes 106 are provided by the user 110, as the user 110 begins with the expansion of the original sentence 112.

The user-expanded sentence 104 is the version of the original sentence 112 created by the user 110 by utilizing the plurality of sentence prefixes 106. The user-expanded sentence 104 reflects the interpretation, creativity, and intent of the user 110. The user-expanded sentence 104 is submitted or provided back to the user interface 114 for evaluation. The grading system 100 aims to help the user 110 to practice and improve their creative writing skills by presenting the original sentence 112. For example: original sentence 112 is “Kayaking is a popular water sport because.” The user-expanded sentence 104 is “Kayaking is a popular water sport because it's exhilarating.” Beneficially, the user-expanded sentence 104 promotes creativity and active engagement by the user 110. The plurality of prefixes 106 ensures flexibility, allowing the user 110 to tailor the expansions of the original sentence 112 to specific contexts, styles, or purposes. In at least one embodiment, the user 110 can be a student, teacher or any person who is using the user interface 114.

In operation 204, a punctuation verification module 116 determines whether the user-expanded sentence 104 ends with proper punctuation. The punctuation verification module 116 is configured to assess punctuation within the user-expanded sentence 104. The punctuation verification module 116 evaluates whether the sentence ends with proper punctuation, such as a period (.), question mark (?), or exclamation mark (!). The punctuation verification module 116 is designed to identify proper punctuation at the end of user-expanded sentence 104. In at least one embodiment, the punctuation verification module 116 includes considerations for various languages, formal or informal writing styles, and potential exceptions, ensuring robust and accurate analysis. Typically, when the user-expanded sentence 104 is generated.

The punctuation verification module 116 operates by analyzing the structure of the user-expanded sentence 104 and determining whether the user-expanded sentence 104 adheres to the basic grammatical rule of appropriate punctuation. If the sentence lacks the correct punctuation, the punctuation verification module 116 provides feedback or a correction suggestion. For example, consider a text-editing platform designed to assist the user 110 such as the student with writing assignments. The student expands the original sentence 112, and the platform uses a punctuation verification module 116 to ensure accurate punctuation. The original sentence 112 is “The garden was full _” and the user-expanded Sentence 104 (entered by the student) is “The garden was full of blooming flowers and buzzing bees.” The punctuation verification module 116 analyzes the user-expanded sentence 104 to detect the absence of punctuation and respond accordingly.

The punctuation verification module 116 determines correctness by checking if the user-expanded sentence 104 ends with a period, question mark, or exclamation mark. The punctuation verification module 116 ensures the correctness of the user-expanded sentence 104 by specifically analyzing its terminal punctuation, focusing on whether user-expanded sentence 104 concludes with the period, question mark, or exclamation mark. By assessing the presence of the punctuation marks, the punctuation verification module 116 establishes whether the user-expanded sentence 104 adheres to the fundamental rules of punctuation. The period signifies the conclusion of a declarative statement, the question mark indicates an inquiry, and the exclamation mark conveys emphasis or heightened emotion. If the required punctuation is missing, the grading system 100 may alert the user 110.

In operation 206, the sentence capitalization verification module 118 assesses whether the user-expanded sentence 104 begins with a capital letter. The sentence capitalization verification module 118 coupled with the punctuation verification module 116 is configured to determine whether the first character of a user-expanded sentence 104 is capitalized. The sentence capitalization verification module 118 is configured with rules that enable it to identify the position and format of the first character of the user-expanded sentence 104. The sentence capitalization verification module 118 evaluates the first character to ensure it conforms to the capitalization standard, specifically that it is an uppercase letter. In at least one embodiment, the sentence capitalization verification module 116 supports multiple languages and varying capitalization rules.

The sentence capitalization verification module 118 assesses whether the user-expanded sentence 104 begins with the capital letter, focusing exclusively on the initial character of the user-expanded sentence 104. For example, the original sentence 112 is provided to the user 110 on the user interface 114 and asks the user 110 to expand upon it. Once the user 110 submits the user-expanded sentence 104, the sentence capitalization verification module 118 ensures that the user-expanded sentence 104 begins with the capital letter. The original Sentence 112 is “The sky was illuminated by thousands of light _.” The user-expanded sentence 104 is “the sky was illuminated by thousands of light and the reflections danced across the water.” In this case, the user-expanded sentence 104 fails to begin with the capital letter. The sentence capitalization verification module 118 would detect this error and provide feedback.

In at least one embodiment, the sentence capitalization verification module 118 also analyzes the surrounding text to determine whether capitalization errors exist within the user-expanded sentence 104. This approach could include identifying inconsistencies in capitalization patterns. The sentence capitalization verification module 118 maintains grammatical precision by automatically verifying the sentence capitalization. The sentence capitalization verification module 118 validates the initial character of the user-expanded sentence 104 as an uppercase letter.

The sentence capitalization verification module 118 ensures grammatical accuracy by validating the initial character of the user-expanded sentence 104, checking that it is the uppercase letter. The sentence capitalization verification module 118 analyzes the first character of the user-expanded sentence 104 submitted by the user 110, determining whether it adheres to the established linguistic convention that sentences begin with the capital letter. The sentence capitalization verification module 118 enforces grammatical standards and also enhances readability. If the initial character fails to meet the requirement, the sentence capitalization verification module 118 can provide immediate feedback, suggesting corrections to rectify the error.

In operation 208, a proper noun capitalization verification module 120 verifies the capitalization of proper nouns in the user-expanded sentence 104. The proper noun capitalization is a critical aspect of written communication, as it distinguishes specific names, places, organizations, and other unique entities from general nouns. The proper noun capitalization verification module 120 is configured to assess user-expanded sentence 104 and validate that all proper nouns are correctly capitalized. The proper noun capitalization verification module 120 evaluates the proper nouns within the user-expanded sentence 104. The Proper nouns, such as “Alice,” “Paris,” or “Microsoft,” require capitalization to signal their unique identity and distinguish them from common nouns like “girl,” “city,” or “company.” The proper noun capitalization verification module 120 is programmed with a set of rules or an algorithm capable of detecting proper nouns and assessing their capitalization status.

For example: the user 110 such as a student expands upon the original sentence 112 and proper noun capitalization verification module 120 ensures that the capitalization of proper nouns is correct. The original sentence is “The capital of France is known _.” The user-expanded sentence 104 is “the capital of france is known for its art and culture.” Here, the user-expanded sentence 104 includes one proper noun: “France”. However, the proper noun, “france,” is incorrectly formatted in lowercase. The proper noun capitalization verification module 120 identifies this error by detecting “france” as a recognized proper noun that should be capitalized. The proper noun capitalization verification module 120 provides feedback to the user 110. By performing the validation, the proper noun capitalization verification module 120 ensures that the user-expanded sentence 104 adheres to grammatical standards, maintaining both the accuracy and clarity of the writing.

In at least one embodiment, the proper noun capitalization verification module 120 involves the use of advanced natural language processing (NLP) systems, such as large language models, which can analyze the user-expanded sentence 104 to detect and correct capitalization errors for proper nouns. Additionally, the use of a proper noun capitalization verification module 120 ensures that user-expanded sentence 104 is grammatically correct and formatted correctly.

The proper noun capitalization verification module 120 detects and evaluates capitalization errors specific to proper nouns using predefined language rules. The proper noun capitalization verification module 120 utilizes the predefined language rules that outline the correct capitalization practices for proper nouns, such as names of people, cities, countries, organizations, and unique entities. The proper noun capitalization verification module 120 systematically scans the user-expanded sentence 104, it isolates words that qualify as proper nouns and evaluates their capitalization status against the predefined language rules. For instance, the proper noun capitalization verification module 120 ensures that words like “New York,” “Elizabeth,” or “Apple” appear with initial uppercase letters, distinguishing them from common nouns. If discrepancies are found such as the lowercase “london” instead of “London” the proper noun capitalization verification module 120 flags the error and may prompt the user 110 with corrective feedback.

In operation 210, a grammar verification module 122 evaluates the grammatical correctness of the user-expanded sentence 104 using a grammar-checking tool 124. The grammar verification module 122 is configured to analyze and evaluate the user-expanded sentence 104 for grammatical correctness. The grammar verification module 122 works in conjunction with the grammar-checking tool 124. The grammar-checking tool 124 is designed to parse text, identify potential grammatical errors, and suggest corrections. Typically, the grammar verification module 122 identifies common grammar issues including subject-verb agreement, sentence structure, punctuation misuse, tense consistency, and other language rules. The grammar verification module 122 is tailored to work seamlessly with the grammar-checking tool 124 to accommodate various languages, dialects, or stylistic preferences.

The grammar verification module 122 operates by receiving the user-expanded sentence 104 as input and processing it through the grammar-checking tool 124. The grammar-checking tool 124 uses a plurality of algorithms to dissect the user-expanded sentence 104 into its grammatical components. It then evaluates these components against predefined grammatical rules, identifying errors or inconsistencies. The process may result in actionable feedback for the user 110. For example: the original sentence 112 is “The artist painted the mural _.” The user-expanded sentence 104 is “The artist painted the mural with vibrant colors which brings life to the otherwise dull walls.” The user-expanded sentence 104 contains a grammatical error “which brings” should be corrected to “which bring” to maintain subject-verb agreement with the plural subject “colors.”

The grammar verification module 122 integrated with the grammar-checking tool 124 ensures grammatical precision, enhancing the readability of the user-expanded sentence 104. The grammar verification module 122 employs the grammar-checking tool 124 which includes third-party grammar-checking tools to identify grammatical errors in the user-expanded sentence 104. The third-party grammar checking tool scrutinizes the user-expanded sentence 104 for errors such as subject-verb agreement, proper tense usage, sentence structure, and punctuation placement. By identifying and flagging these errors, the grammar verification module 122 aids in refining the user-expanded sentence 104 to enhance clarity and coherence.

In operation 212, a conjunction usage verification module 126 assesses the correctness of the usage of a specified conjunction in the user-expanded sentence 104 based on a language model's evaluation. Typically, conjunctions are used in connecting ideas, phrases, clauses, or sentences, and their correct usage is essential for maintaining the flow and clarity of written communication. When the user 110 submits the user-expanded sentence 104, the conjunction usage verification module 126 isolates the conjunction being used and examines its position and role in the user-expanded sentence 104. Then, the conjunction usage verification module 126 cross-references the usage with the grammatical rules governing conjunctions. For example: consider the following original sentence 112 “The boy wanted to play outside _.” The user-expanded sentence 104 is “The boy wanted to play outside but he couldn't because it was raining heavily.” Herein, the conjunction usage verification module 126 focuses on the conjunction “but” and assesses its role within the user-expanded sentence 104. It verifies whether the conjunction properly contrasts the ideas of wanting to play and being unable to due to rain. In this case, the usage is deemed correct as “but” appropriately connects two conflicting ideas. The conjunction usage verification module 126 provides precise, context-aware analysis that enhances the quality of the user-expanded sentence 104 by ensuring conjunctions are used correctly and effectively.

The conjunction usage verification module 126 determines correctness by evaluating both grammatical placement and contextual appropriateness of the specified conjunction using a language model. The conjunction usage verification module 126 examines the grammatical placement of the conjunction within the user-expanded sentence 104, verifying that it adheres to standard rules of syntax, such as proper positioning relative to clauses and alignment with subject-verb relationships. Simultaneously, the conjunction usage verification module 126 evaluates the contextual appropriateness of the conjunction, analyzing whether its usage effectively conveys the intended relationship between connected ideas, such as contrast, addition, cause, or condition. The comprehensive understanding of linguistic patterns and contextual cues of the language model allows the conjunction usage verification module 126 to assess the technical accuracy and coherence of the user-expanded sentence 104.

In operation 214, a sentence expansion verification module 128 identifies whether the user-expanded sentence 104 includes the original sentence 112. The sentence expansion verification module 128 operates by analyzing the user-expanded sentence 104 created by the user 110 that builds upon or elaborates on the original sentence 112. The sentence expansion verification module 128 cross-references the original sentence 112 against the user-expanded sentence 104 input to confirm that it is present in its entirety. The sentence expansion verification module 128 verification ensures that the user-expanded sentence 104 does not omit, alter, or distort the original sentence 112. The sentence expansion verification module 128 scans the user-expanded sentence 104 to locate the original sentence 112, checking for its exact presence.

For example, the original Sentence 112 is “The sky was illuminated by thousands of lights _.” The user-expanded sentence 104 is “the sky was illuminated by thousands of lights and the reflections danced across the water.” The sentence expansion verification module 128 analyzes the user-expanded sentence 104 and confirms that it includes the original sentence 112. The sentence expansion verification module 128 ensures that the user-expanded sentence 104 retains the original sentence 112, promoting consistency and coherence in writing allow user 110 such as the students to elaborate on given statements to practice expansion while maintaining the original content. Below are exemplary programmatic functions utilized to perform various checks on the user-expanded sentence 104.

```
  function gradeSentence(originalSentence, writtenSentence,
conjunction) {
    // Check for punctuation
    punctuationCorrect = hasPunctuation(writtenSentence)
    // Check for sentence capitalization
    sentenceCapsCorrect = hasSentenceCaps(writtenSentence)
    // Check for proper noun capitalization
    properNounCapsCorrect = hasProperNounCaps(writtenSentence)
    // Check grammar using LanguageTool
    grammarCorrect = isGrammarCorrect(writtenSentence)
    // Check conjunction usage with GPT
    conjunctionUsageCorrect =
isConjunctionUsedCorrectly(writtenSentence, conjunction)
    // Check semantics with GPT
    semanticsCorrect = isSemanticsCorrect(writtenSentence)
    // Check if the new sentence contains the original sentence
    sentenceExpansionCorrect =
containsOriginalSentence(originalSentence, writtenSentence)
    // Return the final result
    return {
      punctuation: punctuationCorrect,
      sentenceCaps: sentenceCapsCorrect,
      properNounCaps: properNounCapsCorrect,
      grammar: grammarCorrect,
      conjunctionUsage: conjunctionUsageCorrect,
      semantics: semanticsCorrect,
      sentenceExpansion: sentenceExpansionCorrect
    }
  }
  function hasPunctuation(sentence) {
    // Check if the sentence ends with a period, question mark, or
exclamation point
    return sentence ends with one of [″.″, ″?″, ″!″]
  }
  function hasSentenceCaps(sentence) {
    // Check if the sentence starts with a capital letter
    return first character of sentence is uppercase
  }
  function hasProperNounCaps(sentence) {
    // Check if proper nouns in the sentence are capitalized
    return all proper nouns in sentence are capitalized
  }
  function isGrammarCorrect(sentence) {
    // Use LanguageTool to check grammar
    return LanguageTool.check(sentence) returns no errors
  }
  function isConjunctionUsedCorrectly(sentence, conjunction) {
    // Use GPT to check if the conjunction is used correctly
    return GPT.conjunctionCheck(sentence, conjunction) returns ″Yes″
  }
  function isSemanticsCorrect(sentence) {
    // Use GPT to check the semantics of the sentence
    return GPT.semanticsCheck(sentence) returns ″Yes″
  }
  function containsOriginalSentence(originalSentence, newSentence) {
    // Check if the new sentence contains the original sentence
(ignoring ending punctuation)
    originalWithoutPunctuation = originalSentence without ending
punctuation
    newWithoutPunctuation = newSentence without ending punctuation
    return newWithoutPunctuation contains originalWithoutPunctuation
  }
  function checkSimilarity(first_sentence, second_sentence):
    // Create a prompt template
    template = ″Reply only with ′Different′, ′Similar′, or ′Very
Similar′. How similar in topic are these two sentences?
    First sentence: ′{first_sentence}′
    Second sentence: ′{second_sentence}′
    Response: ″
    // Set up the prompt configuration
    prompt = {
      provider: ″openai″,
      model: ″gpt-4″,
      template: template
    }
    // Send the prompt to the language model and get the response
    response = sendPromptToLanguageModel(prompt, first_sentence,
second_sentence)
    // Parse the response
    if response is empty or undefined:
      return false
    lowercaseResponse = convertToLowerCase(response)
    if lowercaseResponse is ″different″:
      return false
    else if lowercaseResponse is ″similar″ or ″very similar″:
      return true
    else:
      return false // For any unexpected response
  ‘‘‘
  function checkSemantics(text):
    // First semantic check
    result1 = checkSemanticCorrectness(text)
    // Second semantic check
    result2 = checkSentenceMakesSense(text)
    // Return true only if both checks pass
    return result1 and result2
```

The gradeSentence function evaluates various aspects of the user-expanded sentence 104 compared to the original sentence 112 and a specified conjunction. It checks punctuation, capitalization, grammar, conjunction usage, semantics, and whether the user-expanded sentence 104 sentence contains the original sentence 112, returning a summary of these checks as a results object. The hasPunctuation verifies if the user-expanded sentence 104 ends with appropriate punctuation marks (such as “.”, “?”, or “!”) to ensure it is complete. The hasSentenceCaps checks if the user-expanded sentence 104 begins with the capital letter. The hasProperNounCaps ensures that proper nouns in the user-expanded sentence 104 are capitalized correctly, adhering to grammatical conventions. The isGrammarCorrect uses the grammar-checking tool 124 to detect and confirm that the user-expanded sentence 104 is free of grammatical errors. The isConjunctionUsedCorrectly validate if the specified conjunction is used appropriately in the user-expanded sentence 104. The isSemanticsCorrect determines if the user-expanded sentence 104 is semantically coherent, ensuring its meaning makes logical sense. The containsOriginalSentence checks if the user-expanded sentence 104 retains the content of the original sentence 112, ignoring differences in punctuation. The checkSimilarity compare two sentences and classify their similarity as “Different,” “Similar,” or “Very Similar.” It returns true for “Similar” or “Very Similar” and false for “Different.” The checkSemantics performs two independent semantic checks by utilizing prompt 130 on the user-expanded sentence 104 and only passes the user-expanded sentence 104 as semantically correct if both checks succeed.

In operation 216, a prompt generator 132 generates a prompt 130 to guide and constrain the AI engine 108 to perform semantic analysis on the user-expanded sentence 104. The prompt generator 132 is a tool or system designed to create specific instructions or queries, which are then fed into the AI engine 108 to enable it to perform semantic analysis. The prompt generator 132 is configured to construct targeted prompt 130 to instruct the AI engine 108 to focus on specific aspects of the user-expanded sentence 104. The prompt 130 can specify tasks such as analyzing the coherence of the user-expanded sentence 104, identifying relationships between ideas, or verifying that the expansion aligns with the intended context.

An AI engine 108 guided and constrained process begins with the user 110 providing the user-expanded sentence 104 of the original sentence 112. The user-expanded sentence 104 may involve additional context, descriptive elements, or elaboration intended to build upon the original sentence 112. The prompt generator 132 creates a directive or query tailored to the semantic evaluation of the user-expanded sentence 104. The AI engine 108 analyzes the semantic structure of the user-expanded sentence 104. Identify the key themes, verify coherence, and determine whether it elaborates the original sentence 112. The AI engine 108, upon receiving the prompt 130 analyzes the user-expanded sentence 104 and provides feedback to the user 110. In at least one embodiment, the grading system 100 may use predefined semantic templates instead of creating a new prompt for each analysis. For example, the template may be to identify the key ideas and themes in the user-expanded sentence 104 and evaluate whether it aligns with the context of the original sentence 112.

In operation 218, the prompt generator 132 of the programmatic process manager 113 transfers the prompt 130 to the AI engine 108 to determine the semantic correctness of the user-expanded sentence 104 using at least two semantic analysis checks to generate the grade 102. The prompt 130 is provided to the AI engine 108 to instruct the AI engine 108 to analyze the semantic correctness of the user-expanded sentence 104. The prompt 130 serves as the guiding directive for the AI engine 108, specifying the analytical tasks to be performed. The prompt 130 includes explicit instructions to focus on the meaning, coherence, and alignment. In at least one embodiment, the prompt 130 can be prepared by the prompt engineer. To determine the semantic correctness of the user-expanded sentence 104, the AI engine 108 applies at least two distinct semantic analysis checks. These checks are designed to evaluate different aspects such as meaning and structure, providing a comprehensive assessment. The checks include coherence, and alignment checks whether the user-expanded sentence 104 logically extends the original sentence 112 without introducing inconsistencies or contradictions. It ensures that the elaboration aligns with the original meaning and intent. Also, the relevance and consistency check to assess the relevance of the additional details provided in the expansion. It ensures that the elaboration enhances the original sentence 112 without straying into unrelated or irrelevant topics.

The results of the semantic analysis checks are combined to generate the grade 102. The grade 102 reflects how well the user 110 performs on the given original sentence 112. Below is a version of the prompt 130 for semantic correctness of the user-expanded sentence 104.

```
“You are an expert at determining if a sentence makes semantic sense.
Grammatically correct sentences can be semantically incorrect. Here's an
example:
  Sentence: The mouse chases the cat.
  Explanation: While this is grammatically correct, it is not
semantically correct because mice don't chase cats. In fact, cats chase
mice.
  Please ignore spelling mistakes and consider sentences with typos to be
correct if the student attempted to type a word that would have made
sense.
  Now, please output if the sentence is semantically correct or not. If
it is semantically correct, output ′Yes′. And if it is semantically
incorrect, output ′No′.
  {text}″
  // Set up the prompt configuration
  prompt1 = {
    provider: ″openai″,
    model: ″gpt-3.5-turbo″,
    template: template1
  }
  // Send the prompt to the language model and get the response
  response1 = sendPromptToLanguageModel(prompt1, text)
  // Parse the response as Yes/No
  return parseYesNo(response1)
```

The provided prompt 130 is designed to evaluate whether the user-expanded sentence 104 makes semantic sense, focusing on its meaning rather than just its grammatical structure. The AI engine 108 identifies the user-expanded sentence 104 are logically coherent based on real-world knowledge and common sense. For example, “The mouse chases the cat” would be flagged as semantically incorrect despite being grammatically sound because it contradicts natural behavior. Spelling mistakes and typos are ignored as long as the intended meaning is clear, ensuring the focus remains on semantic accuracy. The AI engine 108 utilizes GPT-3.5-turbo owned by OpenAI having headquarters in San Francisco, United States, to return a “Yes” if the user-expanded sentence 104 is semantically correct or “No” if it is not.

Below is the prompt 130 for checking if the user-expanded sentence 104 makes sense.

```
“You are an expert at determining if a sentence makes sense.
Grammatically correct sentences can be semantically incorrect. Here's an
example:
    Sentence: The mouse chases the cat.
    Explanation: While this is grammatically correct, it is not
semantically correct because mice don't chase cats. In fact, cats chase
mice.
    Please ignore spelling mistakes and consider sentences with typos to
be correct if the student attempted to type a word that would have made
sense.
    Now, please output if the sentence makes sense. If it makes sense,
output ′Yes′. And if it makes absolutely no sense, output ′No′.
    Note, don't be super strict on factual errors. Note that young students
are writing these sentences. Just check if the sentence is coherent and
generally makes sense.
    {text}″
    // Set up the prompt configuration
    prompt2 = {
        provider: ″openai″,
        model: ″gpt-3.5-turbo″,
        template: template2
    }
    // Send the prompt to the language model and get the response
    response2 = sendPromptToLanguageModel(prompt2, text)
    // Parse the response as Yes/No
    return parseYesNo(response2)
function parseYesNo(response):
    if response is empty or undefined:
        return null
    else if response.toLowerCase( ) contains ″yes″:
        return true
    else if response.toLowerCase( ) contains ″no″:
        return false
    else:
        return null
function ConjunctionGPTCheck(sentence, conjunction) {
  // Check if the conjunction is ′so′
  isSo = conjunction.toLowerCase( ) == ′so′
  additionalText = ′ ′
  // If the conjunction is ′so′, add additional requirements
  if isSo {
    additionalText = ″And note the word ′so′ shouldn't being used in the
sense of ′I like Abraham Lincoln so much.′ Instead, it should introduce a
phrase that tells us what happened as a result of something else″
  }
  // Return the criteria object
  return {
    label: ‘Does the sentence use the conjunction ″${conjunction}″
correctly?${additionalText}‘,
    evaluate: async function( ) {
      // Use the conjunction check prompt to evaluate the sentence
      correct = await prompts.conjunctionCheck({
        text: sentence.text,
        conjunction: conjunction,
        optionalAdditionalRequirements: additionalText
      }).then(Boolean)
      // Return the evaluation result
      return {
        correct: correct,
        response: yesNo(correct)
      }
    }
  }
}
import necessary modules and functions
// Define a template for the prompt
template = createTemplate({
  text: string,
  conjunction: string,
  optionalAdditionalRequirements: string
}) {
  return ‘You are an expert at determining if a sentence makes sense and
uses conjunctions correctly.
  Does the following sentence use the conjunction ′{{ conjunction }}′
correctly?
  {{ optionalAdditionalRequirements }}
  If it does, output ′Yes′. If it does not, output ′No′.
  {{ text }}
  ‘;
}
// Define the prompt object
prompt = {
  provider: ′openai′,
  model: ′gpt-4′,
  template: template,
  parse: function(content) {
    // Parse the response to determine if it is ′Yes′ or ′No′
    return parseYesNo(content ∥ ′ ′)
  }
}
```

The provided prompt 130 is designed to evaluate whether the user-expanded sentence 104 is coherent, semantically correct, and includes specific conjunctions appropriately while allowing for minor errors like spelling or typos. The focus is on semantic accuracy over grammatical strictness, aiming to help the user 110 to craft meaningful sentences. For example, the sentence like “The cat chases the dog” would be acceptable, but “The dog barks at the clouds, so it swims” might be flagged for incorrect use of the conjunction “so.” The AI engine 108 utilizes GPT-3.5 or GPT-4 owned by OpenAI having headquarters in San Francisco, United States. The parsing function is used to analyze the output, determining “Yes” or “No” responses to indicate whether the user-expanded sentence 104 meets the criteria.

The AI engine 108 performs a two-step verification process to ensure both logical coherence and a general sense of the user-expanded sentence 104, with each step using a distinct semantic evaluation prompt 130 provided by the prompt generator 132. The AI engine 108 is designed to perform the two-step verification process to evaluate the logical coherence and overall sense of the user-expanded sentence 104 to ensure that the user-expanded sentence 104 aligns with the intent of the original sentence 112 and also maintains a clear, meaningful flow of ideas. The first step in this process focuses on logical coherence, where the AI engine 108 assesses the structural and contextual integrity of the user-expanded sentence 104. The prompt 130 is generated by the prompt generator 132 to guide the AI engine 108 to verify whether the user-expanded sentence 104 logically connects its components and makes sense within the intent of the original sentence 112.

The second step evaluates the general sense of the user-expanded sentence 104, ensuring that the elaboration is intuitive and resonates with the intent of the original sentence 112. The prompt 130 directs the AI engine 108 to gauge the overall readability and alignment of the user-expanded sentence 104 with the intended tone and purpose. This step assesses the user-expanded sentence 104 for clarity, relevance, and the appropriateness of additional details.

In operation 220, the AI engine 108 is guided and constrained by prompt 130 to perform operations as a grading module 134 to generate a grade 102 based on outputs of the punctuation verification module 116, sentence capitalization verification module 118, proper noun capitalization verification module 120, grammar verification module 122, conjunction usage verification module 126, sentence expansion verification module 128, and semantic correctness output of the AI engine 108. By combining the outputs of these verification modules, the grading module 134 provides a comprehensive and objective assessment of the user-expanded sentence 104, ensuring grammatical precision, stylistic adherence, and semantic alignment. The grading module 134 coordinates with the AI engine 108 and consolidates the outputs from each module to assign the automated grade 102 that reflects the overall quality of the user-expanded sentence 104

The grading process begins when the punctuation verification module 116 confirms that the user-expanded sentence 104 ends with proper terminal punctuation. The sentence capitalization verification module 118 validates that the user-expanded sentence 104 begins with the capital letter. The proper noun capitalization verification module 120 checks that proper nouns, if any, are correctly capitalized. The grammar verification module 122 verifies grammatical accuracy, such as subject-verb agreement and appropriate tense usage. The conjunction usage verification module 126 ensures the conjunction is appropriately used to connect ideas without introducing redundancy or ambiguity. The sentence expansion verification module 128 confirms that the original sentence 112 is intact within the user-expanded sentence 104. The semantic correctness assesses that the user-expanded sentence 104 adds meaningful context. Based on the outputs of these modules, the grading module 134 assigns the grade 102. The grade 102 is written feedback provided to the user 110 on the user interface 114 mentioning the correctness of the user-expanded sentence 104. The feedback may inform the user 110 of the correct way of adding the plurality sentence prefixes 106,

The grading module 134 provides a detailed breakdown of the generated grade 102 including an indicator for correct, incorrect of the user-expanded sentence 104 and additional information associated with the user-expanded sentence 104. The grading module 134 provides the detailed breakdown of the evaluation including specific insights into the performance across various linguistic and semantic metrics, such as grammar, punctuation, capitalization, sentence expansion, conjunction usage, and semantic correctness. The grading module 134 offers constructive feedback that helps the user 110 to understand their mistakes and improve their writing. In addition, the grading module 134 features the correct or incorrect indicator, making it straightforward for the user 110 to gauge whether the user-expanded sentence 104 meets the required standards. To enhance usability and clarity, the grading module 134 also includes information related to the user-expanded sentence 104. For example, it may identify specific errors, suggest corrections, or provide recommendations for better phrasing or word choice

In at least one embodiment, the grading system 100 can be utilized as an educational tool to assist students in developing better writing habits by providing constructive grammatical feedback. In another embodiment, the grading system can be utilized as a content creation platform to enable writers to produce polished and error-free content for blogs, articles, or social media. In yet another embodiment, the grading system 100 can be used as a collaborative writing system that ensures consistency and accuracy in team-based writing projects.

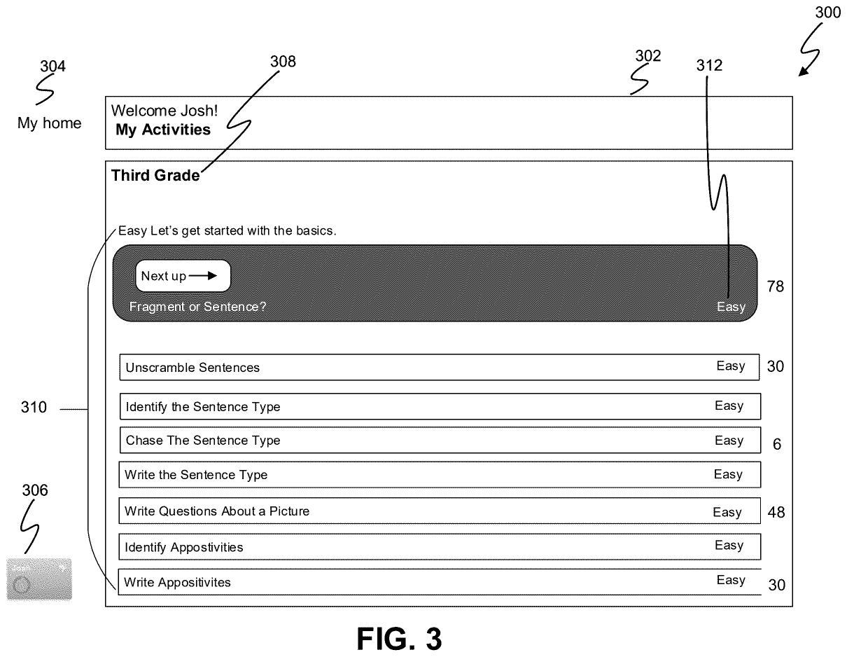

FIGS. 3-8 are exemplary user interfaces 300, 400, 500, 600, 700, and 800 depicting interaction of the user 110. Referring to FIG. 3 depicts the user interface 300 of an online learning platform 302 where the user 110 interacts. As shown, the user interface 300 display my home tab 304 to allow user 110 to reach to a home page of the online learning platform 302. The user 110 can click on a user tab 306 to check the user activity on the online learning platform 302. The user interface 300 display a standard 308 of the user 110. Herein, the user 110 is in third grade. The user interface 300 displays a plurality of topics 310 from which the user 110 can choose to initiate the writing activity. The user interface 300 displays also a difficulty level 312 for each topic from the plurality of topics 310.

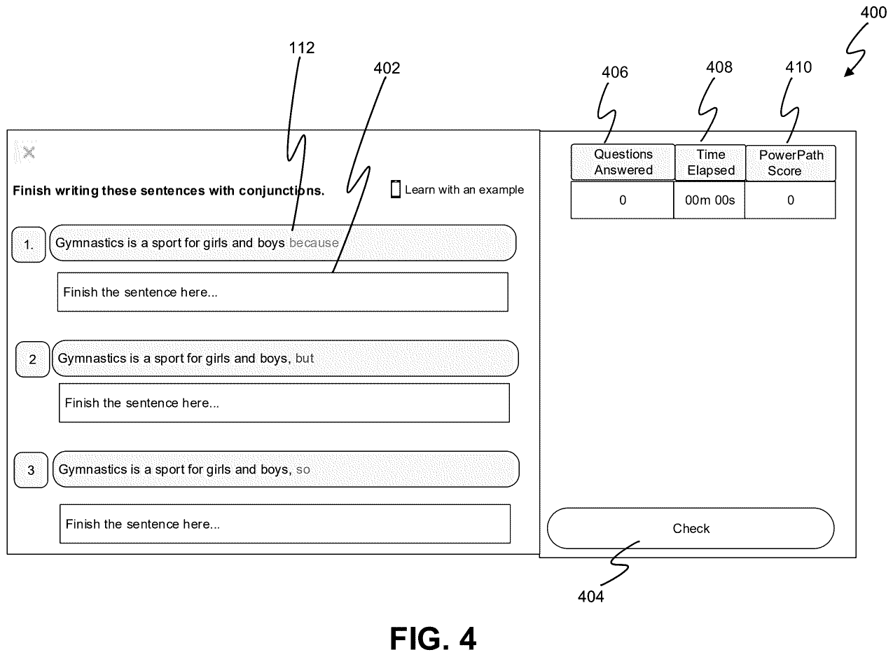

Referring to FIG. 4 depicts the user interface 400 displaying the original sentence 112. The user interface 400 provides a space 402 for the user 110 to provide the user-expanded sentence 104. Once the user 110 provides the user-expanded sentence 104, then the user clicks on a check tab 404 to initiate the verification process. the user interface 400 displays a question answered tab 406, a time elapsed tab 408 and a powerpath score tab 410. The question answered tab 406 displays the number of questions answered by the user 110. The time elapsed tab 408 displays the time taken by the user 110 to provide the answers to the displayed questions. The powerpath score tab 410 displays the score based on the correctness of the answer.

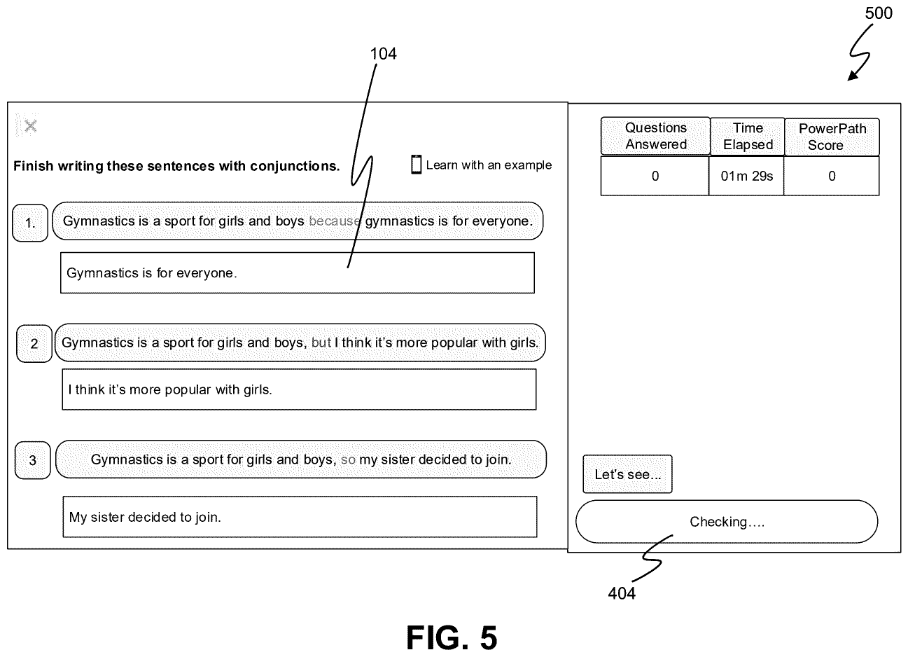

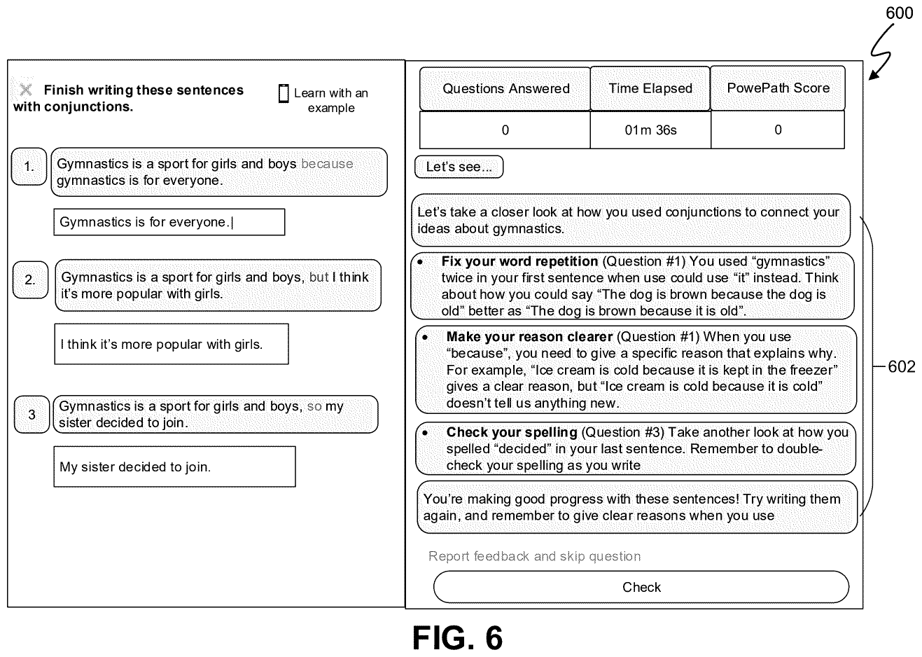

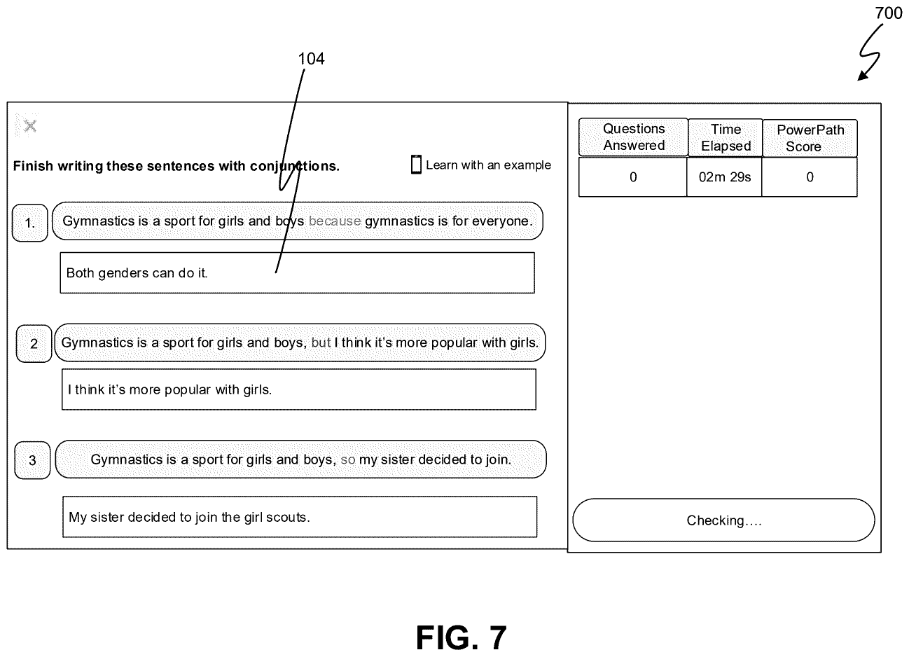

Referring to FIG. 5 depicts the user interface 500, as shown the user 110 has provided the user-expanded sentence 104 and clicked on the check tab 404 for checking the user-expanded sentence 104. Referring to FIG. 6 depicts the user interface 600 displays a detailed feedback 602 based on the user-expanded sentence 104. Moreover, the user interface 600 allows the user 110 to rewrite the user-expanded sentence 104 based on the provided detailed feedback 602. Referring to FIG. 7 depicts the user interface 700, the user 110 has rewritten the user-expanded sentence 104 and clicked on the check tab 404 for checking the rewritten user-expanded sentence 104.

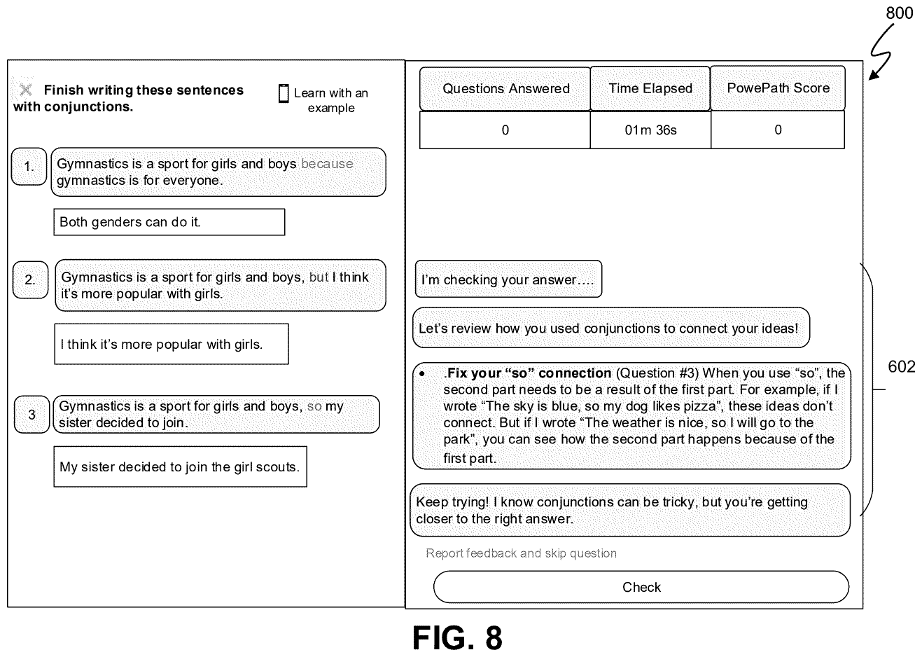

Referring to FIG. 8 depicts the user interface 800, the revised detailed feedback 602 is generated based on the rewritten user-expanded sentence 104.

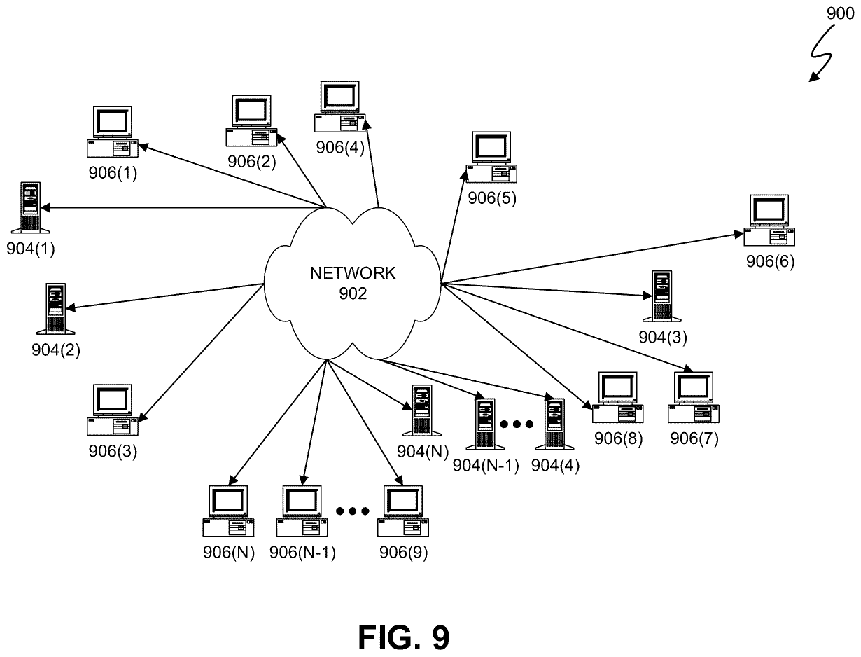

FIG. 9 is a block diagram illustrating a network environment in which a grading system 100 and grading process 200 may be practiced. Network 902 (e.g. a private wide area network (WAN) or the Internet) includes a number of networked server computer systems 904(1)-(N) that are accessible by client computer systems 906(1)-(N), where N is the number of server computer systems connected to the network. Communication between client computer systems 906(1)-(N) and server computer systems 904(1)-(N) typically occurs over a network, such as a public switched telephone network over asynchronous digital subscriber line (ADSL) telephone lines or high-bandwidth trunks, for example communications channels providing T1 or OC3 service. Client computer systems 906(1)-(N) typically access server computer systems 904(1)-(N) through a service provider, such as an internet service provider (“ISP”) by executing application specific software, commonly referred to as a browser, on one of client computer systems 906(1)-(N).

Client computer systems 906(1)-(N) and/or server computer systems 904(1)-(N) are specialized computer programmed to improve conventional computer systems to implement and utilize the grading system 100 and grading process 200. The type of computer system that can be specially programmed to implement and utilize the grading system 100 and grading process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the grading system 100 and grading process 200 can be implemented using code stored in a tangible, non-transient computer readable medium and executed by one or more processors. In at least one embodiment, the grading system 100 and grading process 200 can be implemented completely in hardware using, for example, logic circuits and other circuits including field programmable gate arrays.

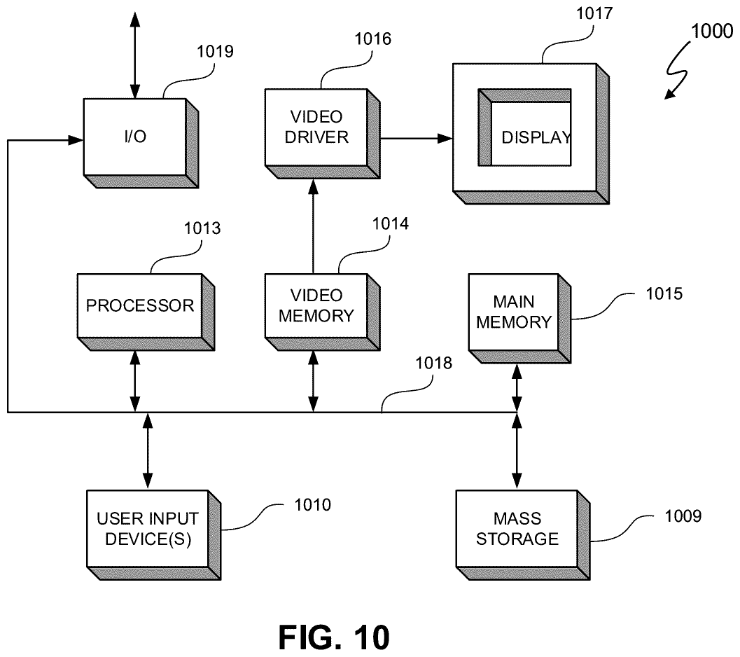

Embodiments of the grading system 100 and grading process 200 can be implemented on a computer system such as a special-purpose, special-programmed computer 1000 illustrated in FIG. 10. Input user device(s) 1010, such as a keyboard and/or mouse, are coupled to a bi-directional system bus 1018. The input user device(s) 1010 are for introducing user input to the computer system and communicating that user input to processor 1013. The computer system of FIG. 10 generally also includes a non-transitory video memory 1014, non-transitory main memory 1015, and non-transitory mass storage 1009, all coupled to bi-directional system bus 1018 along with input user device(s) 1010 and processor 1013. The mass storage 1009 may include both fixed and removable media, such as a hard drive, one or more CDs or DVDs, solid state memory including flash memory, and other available mass storage technology. Bus 1018 may contain, for example, 32 of 64 address lines for addressing video memory 1014 or main memory 1015. The system bus 1018 also includes, for example, an n-bit data bus for transferring DATA between and among the components, such as CPU Y09, main memory 1015, video memory 1014 and mass storage 1009, where “n” is, for example, 32 or 64. Alternatively, multiplex data/address lines may be used instead of separate data and address lines.

I/O device(s) 1019 may provide connections to peripheral devices, such as a printer, and may also provide a direct connection to a remote server computer systems via a telephone link or to the Internet via an ISP. I/O device(s) 1019 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 1009, into main memory 1015 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1013, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1015 is comprised of dynamic random access memory (DRAM). Video memory 1014 is a dual-ported video random access memory. One port of the video memory 1014 is coupled to video amplifier 1016. The video amplifier 1016 is used to drive the display 1017. Video amplifier 1016 is well known in the art and may be implemented by any suitable means. This circuitry converts pixel DATA stored in video memory 1014 to a raster signal suitable for use by display 1017. Display 1017 is a type of monitor suitable for displaying graphic images.

The computer system described above is for purposes of example only. The grading system 100 and grading process 200 may be implemented in any type of computer system or programming or processing environment. It is contemplated that the grading system 100 and grading process 200 might be run on a stand-alone computer system, such as the one described above. The grading system 100 and grading process 200 might also be run from a server computer systems system that can be accessed by a plurality of client computer systems interconnected over an intranet network. Finally, the grading system 100 and grading process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method for integrating programmatic functions and a guided and constrained artificial intelligence (AI) engine to automatically grade a user-expanded sentence using a plurality of sentence prefixes in writing activities, the method comprising:
executing code using one or more processors of a computer system to cause the computer system to perform operations comprising:
receiving the user-expanded sentence from a user having the plurality of sentence prefixes on an original sentence;
using a punctuation verification module configured to determine whether the user-expanded sentence ends with proper punctuation;
using a sentence capitalization verification module configured to assess whether the user-expanded sentence begins with a capital letter;
using a proper noun capitalization verification module configured to verify capitalization of proper nouns in the user-expanded sentence;
using a grammar verification module configured to evaluate the grammatical correctness of the user-expanded sentence using a grammar-checking tool;
using a conjunction usage verification module configured to assess the correctness of the usage of a specified conjunction in the user-expanded sentence based on a language model's evaluation;
using a sentence expansion verification module configured to identify whether the user-expanded sentence includes the original sentence;
generating a prompt by a prompt generator to guide the AI engine to perform semantic analysis on the user-expanded sentence;
transferring the prompt to the AI engine to determine the semantic correctness of the user-expanded sentence using at least two semantic analysis checks to generate the grade; and
using a grading module operative coupled with the AI engine to automatically grade based on outputs of the punctuation verification module, sentence capitalization verification module, proper noun capitalization verification module, grammar verification module, conjunction usage verification module, sentence expansion verification module, and semantic correctness.

2. The method of claim 1, wherein the punctuation verification module determines correctness by checking if the user-expanded sentence ends with a period, question mark, or exclamation mark.

3. The method of claim 1, wherein the sentence capitalization verification module validates the initial character of the user-expanded sentence as an uppercase letter.

4. The method of claim 1, wherein the proper noun capitalization verification module detects and evaluates capitalization errors specific to proper nouns using a predefined language rules.

5. The method of claim 1, wherein the grammar verification module employs the grammar-checking tool includes third-party grammar checking tools to identify grammatical errors in the user-expanded sentence.

6. The method of claim 1, wherein the conjunction usage verification module determines correctness by evaluating both grammatical placement and contextual appropriateness of the specified conjunction using a language model.

7. The method of claim 1, wherein the AI engine performs a two-step verification process to ensure both logical coherence and a general sense of the user-expanded sentence, with each step using a distinct semantic evaluation prompt provided by the prompt generator.

8. The method of claim 1, wherein the grading module provides a detailed breakdown of the generated grade including an indicator for correct, incorrect of the user-expanded sentence and additional information associated with the user-expanded sentence.

9. A system for integrating programmatic functions and a guided and constrained artificial intelligence (AI) engine to automatically grade a user-expanded sentence using a plurality of sentence prefixes in writing activities, the system comprising:
one or more processors of a computer system;
memory, coupled to the one or more processors, that stores code and execution of the code by the one or more processors causes the computer system to perform operations comprising:
receiving the user-expanded sentence from a user having the plurality of sentence prefixes on an original sentence;
using a punctuation verification module configured to determine whether the user-expanded sentence ends with proper punctuation;
using a sentence capitalization verification module configured to assess whether the user-expanded sentence begins with a capital letter;
using a proper noun capitalization verification module configured to verify capitalization of proper nouns in the user-expanded sentence;
using a grammar verification module configured to evaluate the grammatical correctness of the user-expanded sentence using a grammar-checking tool;
using a conjunction usage verification module configured to assess the correctness of the usage of a specified conjunction in the user-expanded sentence based on a language model's evaluation;
using a sentence expansion verification module configured to identify whether the user-expanded sentence includes the original sentence;
generating a prompt by a prompt generator to guide the AI engine to perform semantic analysis on the user-expanded sentence;
transferring the prompt to the AI engine to determine the semantic correctness of the user-expanded sentence using at least two semantic analysis checks to generate the grade; and
using a grading module operative coupled with the AI engine to automatically grade based on outputs of the punctuation verification module, sentence capitalization verification module, proper noun capitalization verification module, grammar verification module, conjunction usage verification module, sentence expansion verification module, and semantic correctness.

10. The system of claim 9, wherein the punctuation verification module determines correctness by checking if the user-expanded sentence ends with a period, question mark, or exclamation mark.

11. The system of claim 9, wherein the sentence capitalization verification module validates the initial character of the user-expanded sentence as an uppercase letter.

12. The system of claim 9, wherein the proper noun capitalization verification module detects and evaluates capitalization errors specific to proper nouns using a predefined language rules.

13. The system of claim 9, wherein the grammar verification module employs the grammar-checking tool includes third-party grammar checking tools to identify grammatical errors in the user-expanded sentence.

14. The system of claim 9, wherein the conjunction usage verification module determines correctness by evaluating both grammatical placement and contextual appropriateness of the specified conjunction using a language model.

15. The system of claim 9, wherein the AI engine performs a two-step verification process to ensure both logical coherence and a general sense of the user-expanded sentence, with each step using a distinct semantic evaluation prompt provided by the prompt generator.

16. The system of claim 9, wherein the grading module provides a detailed breakdown of the generated grade including an indicator for correct, incorrect of the user-expanded sentence and additional information associated with the user-expanded sentence.
